(19) United States
(12) Patent Application Publication
(10) Pub. No.: US 2011/0258658 A1
(43) Pub. Date: Oct. 20, 2011

(54) METHOD OF BROADCASTING DIGITAL CONTENT, NETWORK AND TERMINAL FOR IMPLEMENTING THAT METHOD

(76) Inventor: Bahman Mobasser, Maurepas (FR)

(21) Appl. No.: 12/988,041

(22) PCT Filed: Apr. 9, 2009
(86) PCT No.: PCT/FR09/50633

§ 371 Date: Apr. 29, 2011

(30) Foreign Application Priority Data
Apr. 15, 2008 (FR) 0802077

(51) Int. Cl. H04N 7/167; H04N 7/16

(52) U.S. Cl. 725/31; 725/25

(57) ABSTRACT

A method of broadcasting digital content, a date being fixed for when this content is made accessible to a target audience, which method comprises:
the distribution of the digital content to a storage memory before said date, with a digital rights management tool prevent access to said content,
the distribution, to the communication terminal, on said date, of a command to open access rights to said content.

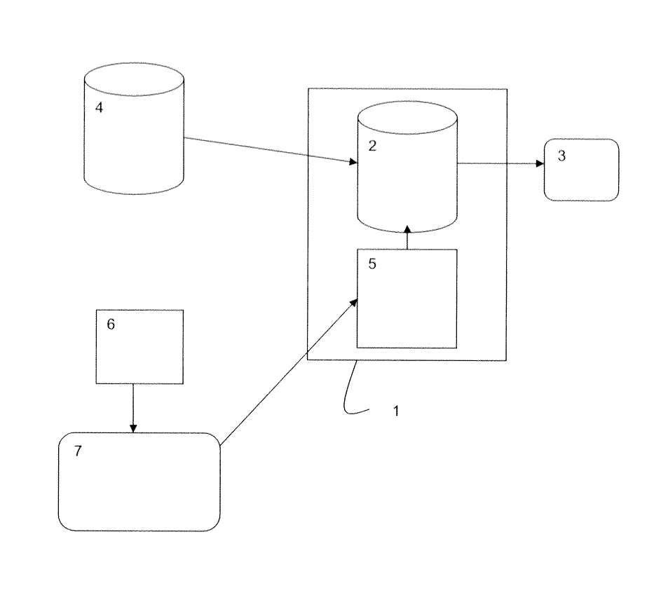

The invention pertains to the technical field of telecommunications.

The invention more particularly pertains to controlling the distribution of digital content.

On various occasions, it is desirable to impose a date of broadcasting information to a target audience,

Here, “information” refers to any text and/or audio and/or video data, whether this data is for commercial, entertainment, scientific, technical, or other purposes,

A few examples of these situations are described below.

A new movie or a new song must not be accessible to the audience before the date selected by the artist or his or her producer. An advertising campaign makes it possible in such cases to raise growing interest in the new product, which remains confidential until the announced date. The publicity given to the product launch may thereby be maximized, using buzz marketing techniques. Blogs, forums, and websites make it possible to build interest and curiosity among potential customers of a new product which is not yet available but whose date and time of release are being widely publicized.

Legal or regulatory information is generally made accessible on a fixed date to all of the relevant people. The same holds true, in particular, for the financial reports of publicly traded companies, statistics regarding the national economy, and patents and patent applications.

A supplier of information, such as a press agency or a journalist, may be contractually or legally prohibited from releasing information before a predetermined date.

If a serious event were to occur, a widely distributed press release may state that important information will be communicated or made available on a specific date.

Whenever such situations occur, the demand for information on D day will be at a maximum. There is therefore a risk, for the supplier of information, of being unable to meet the requests.

Whenever the information is released electronically, an excessive number of download requests may clog the servers. Whenever the information is a large digital file (such as a video), the network's capacities may prove insufficient to meet this spike in requests. Whenever the information is available on mobile communication terminals (PDAs, smartphones), the risks of overload are greater. In 1995, there were 34 million cellular telephone subscribers in the United States (statistics from the Cellular Telecommunications and Internet Association). Currently, the number of cell phone subscribers in the United States is estimated to be 116 million.

In the event of overload, there is a risk that information may be broadcast partially and unequally.

The invention aims to remedy these technical problems by disclosing a method for broadcasting digital information on a fixed and predetermined date, which method ensures equal access to that information, independent of the size of the digital file and the bit rate provided by the network for accessing that digital information.

For these purposes, the invention, according to a first aspect, pertains to a method for broadcasting digital content, a date being fixed so that this content is made accessible to a target audience, which method comprises the broadcasting of the digital content onto a storage memory prior to said date, a digital rights management tool preventing access to the content, and the broadcasting, to the communication terminal, on said date, of a command opening access rights to said content.

Advantageously, the command to open the rights is sent to an electronic program guide, the digital content being, for example, a video from a video-on-demand service.

Advantageously, at least part of the digital content is distributed via the Internet, or by microwaves or satellite.

In a variant or in a combination, at least one part of the digital content is distributed via a mobile communications network.

In one embodiment, the storage memory is within a home transit node or gateway (residential gateway).

In another embodiment, the storage memory is within the communication terminal.

In one embodiment, the method further comprises the display synchronization, by the communication terminal, of the digital content with the transmission of that digital content to all of the potential receiving terminals.

Advantageously, the digital content broadcast before said data is encrypted, the command to open the rights to access that content comprising a decryption key.

According to a second aspect, the invention pertains to a telecommunications network of broadcasting digital content, a date being fixed for when this content is made accessible to a target audience, which network comprises means for broadcasting digital content to a storage memory prior to said date, and a digital rights management tool preventing access to the content, which network further comprises means for the broadcasting, to the communication terminal, on said date, of a command opening access rights to said content.

According to a third aspect, the invention pertains to a communication terminal for receiving digital content, a date being fixed for when this content is made accessible to a target audience, which terminal comprises means for receiving the digital content prior to said date, and a digital rights management tool preventing access to the content, which terminal further comprises a storage memory for storing said content and means for receiving, on said date, a command opening access rights to said content.

Other objects and advantages of the invention will become apparent upon reading the following description of currently preferred embodiments, which will be carried out with reference to the attached drawing.

In the embodiment depicted, the user has a private subscriber equipment 1 (CPE Customer Premise Equipment), such as a digital assembly device (set top box).

This equipment 1 has a memory 2, advantageously a cache memory.

In one embodiment, the cache memory is within a home transit node or gateway (residential gateway).

This equipment 1 is connected to a viewing monitor 3, for example a computer screen or television set.

The media content is sent to the equipment 1, from a content database 4, on a date T1.

This data may be distributed by wires or wirelessly, and if appropriate, partially over the Internet.

The date T1 is different from the one T2 when the content will be accessible to the user. A digital rights management tool 5 prevents the content that is distributed and stored in the memory 2 from being read.

On the public release date T2 a command to open the rights is sent to the equipment. This command comes from the service provider 6.

In one embodiment, whenever the media content is video-on-demand, an electronic program guide 7 enables the user to become aware of the following information:
the video is currently being received,
the video will be accessible starting from date T2,
the video was fully received and is saved in the local memory.

In one embodiment, an encryption of the saved content is removed by the user by entering a decryption key sent by the service provider. A message informs the user that this decryption key has been received.

In one advantageous embodiment, the digital content is a television program. The network's load may prove too heavy, when certain television programs are broadcast simultaneously to all viewers. The method makes it possible to remedy this problem, by separating out beforehand the distribution of the programs and their release. More specifically, the television program is delivered to the user, without the user necessarily being notified of it, and this program is stored in a cache memory, for example in a residential gateway. The delivery of the program is not necessarily carried out by normal distribution channels. For example, the program may reach the cache memory by radio or satellite means. The received content is advantageously encrypted. The television program is made available by sending a decryption key. Whenever the user chooses to view the program when it is broadcast, a synchronization is carried out between the local displaying of the program stored locally in cache memory and the receipt of the broadcast program. Thus, the user perceives that the television program is arriving by the traditional method. The separation between transport time and the ne|ease of digital content is therefore hidden from the user.

The invention has several advantages.

First, the most popular digital content, or that which is expected or predicted to be very successful, may be released to users, without the risk that networks or servers will become saturated by an excessive number of download requests. For example, media content (films, videos, clips, songs) are distributed to the terminals of users or potential purchasers when the network is less-used, such as at night.

If the user decides to purchase a video which is expected to be very successful, such as a pay per view video, he or she need only send this information, at any time, to the VoD (Video on Demand) platform, the video being saved at the user's home to be released on a later date.

The service provider has control over the storage memory and the digital rights management tool within in the user's equipment. The service provider is the one who sends a command to release digital content to the digital rights management tool from among the content previously saved in the memory.

1. A method of broadcasting digital content, a date being fixed for when this content is made accessible to a target audience, which method comprises:
the distribution of the digital content to a storage memory before said date, with a digital rights management tool prevent access to said content,
the distribution, to the communication terminal, on said date, of a command to open access rights to said content.

2. A method according to claim 1, wherein the command to open the rights is sent to an electronic program guide.

3. A method according to claim 1, wherein at least part of the digital content is distributed via Internet or by radio or satellite broadcast.

4. A method according to claim 1, wherein at least part of the digital content is distributed via a mobile telecommunications network.

5. A method according to claim 1, wherein the storage memory is internal to the communication terminal.

6. A method according to claim 1, wherein it further comprises the display synchronization, by the communication terminals, of the digital content with the transmission of this digital content to all of the potential receiving terminals.

7. A method according to claim, wherein the digital content distributed before said date is encrypted, the command to open rights to access said content comprising a decryption key.

8. A telecommunications network of broadcasting digital content, a date being fixed for when this content is made accessible to a target audience, which network comprises:
means of broadcasting digital content to a storage memory, before said date, with a digital rights management tool preventing access to said content,
means of broadcasting, to the communication terminal, on said date, of a command to open access rights to said content.

9. A communication terminal for receiving digital content, a date being fixed so that this content is made accessible to a target audience, which terminal comprises:
means for receiving the digital content, before said date, with a digital rights management tool preventing access to said content,
a storage memory for storing said content;
means for receiving, on said date, a command to open rights to access said content.
